(19) United States
(12) Patent Application Publication
(10) Pub. No.: US 2022/0063635 A1
(43) Pub. Date: Mar. 3, 2022

(54) VEHICLE CONTROLLER AND HEADWAY DISTANCE CONTROL METHOD USING THE SAME

(71) Applicants: HYUNDAI MOTOR COMPANY, Seoul (KR); Kia Corporation, Seoul (KR)

(72) Inventor: Dae Young KIM, Gwangmyeong-si (KR)

(73) Assignees: HYUNDAI MOTOR COMPANY, Seoul (KR); Kia Corporation, Seoul (KR)

(21) Appl. No.: 17/460,891

(22) Filed: Aug. 30, 2021

(30) Foreign Application Priority Data
Aug. 31, 2020 (KR) 10-2020-0110280

(51) Int. Cl. B60W 40/09; B60W 30/16

(52) U.S. Cl. CPC B60W 40/09; B60W 2540/229; B60W 2540/225; B60W 30/162

(57) ABSTRACT

A vehicle controller and a headway distance control method are provided. The vehicle controller includes an object information obtaining device that obtains information about an object around a vehicle, a forward gazing detecting device that detects whether a driver in the vehicle keeps his or her eyes on the road, and a headway distance controller that controls a headway distance between the vehicle and a forward vehicle which is traveling in front of the vehicle depending on whether the driver keeps his or her eyes on the road.

### CROSS-REFERENCE TO RELATED APPLICATION

This application claims the benefit of priority to Korean Patent Application No. 10-2020-0110280, filed in the Korean Intellectual Property Office on Aug. 31, 2020, the entire contents of which are incorporated herein by reference.

### TECHNICAL FIELD

The present disclosure relates to a vehicle controller and a headway distance control method using the same, and more particularly, relates to a vehicle controller using advanced driver assistance systems (ADAS) and a headway distance control method using the same.

### BACKGROUND

Existing longitudinal direction, such as headway distance control or speed control, is performed according to a headway distance level and a setting speed set by a driver, irrespective of whether the driver keeps his or her eyes on the road.

However, the system does not maintain a headway distance in all situations. For example, when a forward vehicle decelerates suddenly, there may occur a control limit situation to which the system does not respond. In this case, a conventional system requests the driver to take over longitudinal control authority (take-over-request).

When the driver keeps his or her eyes on the road, in the limit situation, the driver may recognize a risk of a head-on collision before the take-over-request to brake. However, when the limit situation occurs suddenly in the situation where the driver does not keep his or her eyes on the road, there is a high probability that response ability to prevent a head-on collision by braking of the driver will be reduced.

At this time, although the driver does not respond to it, a safety assist system, such as forward collision-avoidance assist (FCA), operates to prevent a head-on collision. However, there may still be a sense of fatigue/inconvenience of the driver according to sudden braking.

Thus, there is a need for a method for suppressing the occurrence of a limit situation or increasing a time taken for the driver to respond to the limit situation, in the situation where the driver does not keep his or her eyes on the road.

### SUMMARY

The present disclosure has been made to solve the above-mentioned problems occurring in the prior art while advantages achieved by the prior art are maintained intact.

An aspect of the present disclosure provides a vehicle controller for suppressing the occurrence of a limit situation or increasing a time taken for the driver to respond to the limit situation, when the driver does not keep his or her eyes on the road, and a headway distance control method using the same.

Another aspect of the present disclosure provides a vehicle controller for supplementing a limit in longitudinal control of a driving convenience system, such as smart cruise control (SCC) or highway driving assist (HDA), in a situation where the driver does not keep his or her eyes on the road, and a headway distance control method using the same.

Another aspect of the present disclosure provides a vehicle controller for preventing an accident from occurring due to non-response of the driver or preventing a driving safety system, such as forward collision-avoidance assist (FCA), from being enabled, and a headway distance control method using the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle controller may include an object information obtaining device that obtains information about an object around a vehicle, a forward gazing detecting device that detects whether a driver in the vehicle keeps his or her eyes on the road, and a headway distance controller that controls a headway distance between the vehicle and a forward vehicle which is traveling in front of the vehicle depending on whether the driver keeps his or her eyes on the road.

The headway distance controller may set a headway level to a predetermined level, when the driver does not keep his or her eyes on the road. The vehicle controller may further include an operation system that operates the vehicle depending on the set headway level.

The headway distance controller may set the predetermined level to a maximum headway level corresponding to the highest level among levels for headway adjustment.

The headway distance controller may set a level higher than a headway level set by the driver to the predetermined level.

The headway distance controller may set a headway level which becomes higher in response to a time when the driver does not keep his or her eyes on the road to the predetermined level.

The headway distance controller may set an additional headway distance penalty based on one of a current headway level, a current vehicle speed, or a time when the driver does not keep his or her eyes on the road, when the driver does not keep his or her eyes on the road.

The vehicle controller may further include a braking system that brakes the vehicle. The headway distance controller may increase a maximum amount of deceleration of the braking system, when the driver does not keep his or her eyes on the road.

The maximum amount of deceleration may be set based on one of a current vehicle speed, a distance from the forward vehicle, a speed of the forward vehicle, or a time when the driver does not keep his or her eyes on the road.

The headway distance controller may limit a maximum driving speed of the vehicle, when the driver does not keep his or her eyes on the road. The vehicle controller may further include an operation system that operates the vehicle depending on the maximum driving speed.

The headway distance controller may set an amount of acceleration of the vehicle when the driver does not keep his or her eyes on the road to be lower than an amount of acceleration of the vehicle when the driver keeps his or her eyes on the road. The vehicle controller may further include an operation system that operates the vehicle depending on the set amount of acceleration.

The vehicle controller may further include a user interface that notifies the driver of operation information of the vehicle which is traveling based on a changed headway distance, when the driver does not keep his or her eyes on the road.

According to another aspect of the present disclosure, a headway distance control method may include obtaining information about an object around a vehicle, detecting whether a driver in the vehicle keeps his or her eyes on the road, and controlling a headway distance between the vehicle and a forward vehicle which is traveling in front of the vehicle depending on whether the driver keeps his or her eyes on the road.

### BRIEF DESCRIPTION OF THE DRAWINGS

The above and other objects, features and advantages of the present disclosure will be more apparent from the following detailed description taken in conjunction with the accompanying drawings:

FIG. 1 is a control block diagram illustrating a vehicle controller according to an embodiment of the present disclosure;

FIG. 2 is a control flowchart illustrating a headway distance control method according to an embodiment of the present disclosure;

FIG. 3 is a control flowchart illustrating a method for changing a headway level according to an embodiment of the present disclosure;

FIG. 4 is a control flowchart illustrating a method for changing a headway level according to another embodiment of the present disclosure;

FIG. 5 is a control flowchart illustrating setting an additional headway distance penalty according to an embodiment of the present disclosure;

FIG. 6 is a control flowchart illustrating setting the maximum amount of deceleration according to an embodiment of the present disclosure;

FIG. 7 is a control flowchart illustrating setting the maximum amount of deceleration according to another embodiment of the present disclosure;

FIG. 8 is a control flowchart illustrating a method for limiting a driving speed according to an embodiment of the present disclosure;

FIG. 9 is a control flowchart illustrating a method for limiting a driving speed according to another embodiment of the present disclosure; and

FIG. 10 is a block diagram illustrating a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

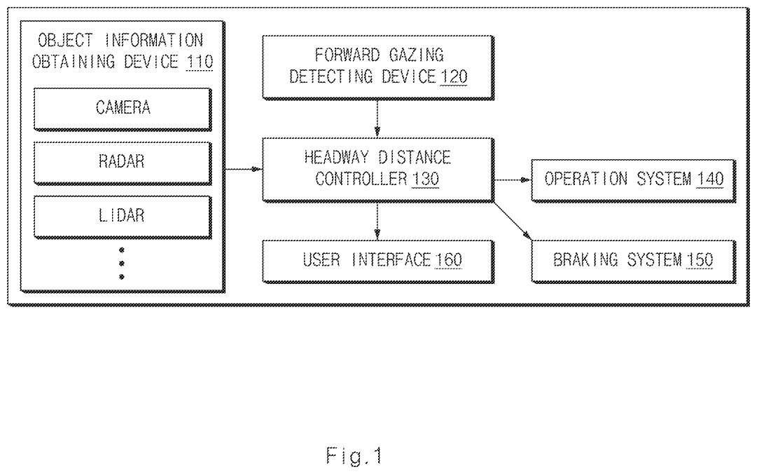

Hereinafter, embodiments of the present disclosure will be described in detail with reference to FIGS. 1 to 9.

FIG. 1 is a control block diagram illustrating a vehicle controller according to an embodiment of the present disclosure.

The vehicle controller according to an embodiment of the present disclosure is not limited to a conventional vehicle and is applicable to a two-wheeled vehicle or a flight vehicle. When a means of transportation operates in a longitudinal direction and when there is a need to control a distance from a means of transportation located in front of the means of transportation depending on an operation direction, the vehicle controller according to an embodiment of the present disclosure is applicable. Here, hereinafter, as an example, a description will be given of a headway distance control method applicable to a vehicle capable of performing autonomous driving.

As shown, the vehicle controller according to an embodiment of the present disclosure may include an object information obtaining device 110, a forward gazing detecting device 120, a headway distance controller 130, an operation system 140 capable of operating under control of the headway distance controller 130, a braking system 150, and a user interface 160. The vehicle controller may be implemented by means of mutual control and communication of configuration modules forming several systems in the vehicle.

The object information obtaining device 110 may obtain information about an object around the vehicle. To this end, as shown, the object information obtaining device 110 may include a plurality of various sensors and an imaging device. As an example, the object information obtaining device 110 may further include a camera, a radar, and/or a light detection and ranging (LIDAR), which is shown, or an ultrasonic sensor which is not shown, or other components capable of recognizing or detecting an object around the vehicle. In the present disclosure, the object may include another vehicle around the vehicle, a wall, facilities, animals including persons, or the like and particularly may include a vehicle and an object which is traveling in a direction where a driving vehicle is driving.

The camera may capture an image of the front, the rear, or the like of the vehicle to show a user the image, and the image may be displayed on the user interface 160.

The LIDAR may be a system which measures a time taken to return after the emitted laser pulse is reflected and measures location coordinates of a reflector. The radar may correspond to a device for detecting a location, a speed, or the like of an object using a radio wave which returns after the radio wave is emitted. As a result, the obtained information about an object, facilities, or the like which is present around the vehicle or is present in a space around the vehicle may be provided to the headway distance controller 130.

The forward gazing detecting device 120 may detect whether a driver in the vehicle keeps his or her eyes on the road, that is, a state of the driver. The forward gazing detecting device 120 may be implemented as a monitoring camera for capturing the appearance of the driver, a sensor for determining driver's hands-off, or the like.

When the forward gazing detecting device 120 is implemented as the sensor for detecting the driver's hands-off, it may determine a situation where the driver takes his or her hands off the steering wheel as a situation where the driver does not keep his or her eyes on the road.

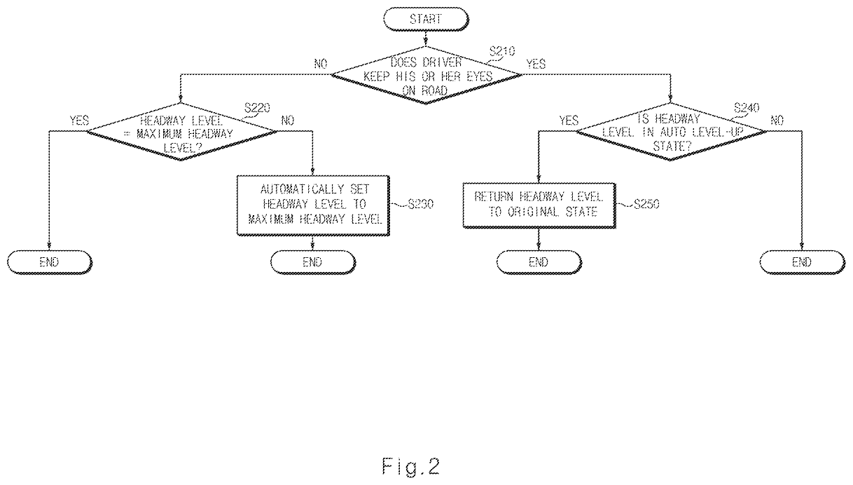

The headway distance controller 130 may generate various control signals for controlling a headway distance between the vehicle and a forward vehicle which is traveling in front of the vehicle, depending on whether the driver keeps his or her eyes on the road detected by the forward gazing detecting device 120. The headway distance controller 130 may control operation or braking of the vehicle by means of such control signals and may adjust an inter-vehicle distance, that is, a headway distance. The headway distance control will be described in detail with reference to FIGS. 2 to 9.

The operation system 140 may be a system associated with driving of the vehicle including a steering module and an acceleration module. Autonomous driving may be performed by means of the operation system 140.

Furthermore, the braking system 150 may include a braking module associated with decelerating and stopping the vehicle. A maximum amount of deceleration or a maximum driving speed may be controlled according to the headway distance controller 130.

When the driver does not keep his or her eyes on the road, the user interface 160 may correspond to a configuration for notifying the driver of operation information of the vehicle which is traveling based on the headway distance changed by the headway distance controller 130.

The user interface 160 may be implemented as various media capable of inputting and outputting a voice or displaying an image and receiving a user input and selection. For example, the user interface 160 may be implemented as a human machine interface.

The user interface 160 may notify a user of information about a headway level, a headway distance, a maximum amount of deceleration, a maximum driving speed, or the like, which is changed because the driver does not keep his or her eyes on the road.

When an existing control system for maintaining a headway distance sets the headway distance to be short, it may fail to correspond to emergency braking of a forward vehicle using system limit deceleration. In this case, when the driver keeps his or her eyes on the road, a head-on collision situation may be avoided as the driver manipulates a brake pedal. However, when the driver does not keep his or her eyes on the road, there is a very high probability that a head-on collision will occur. Thus, according to an example, when the driver does not keep his or her eyes on the road, an inter-vehicle level (a headway level) or an inter-vehicle distance (a headway distance) may be compulsorily increased. FIGS. 2 to 5 are drawings illustrating an example of it. A risk of a head-on collision according to sudden deceleration of a forward vehicle in the situation where the driver does not keep his or her eyes on the road may be reduced by means of such embodiments.

FIG. 2 is a control flowchart illustrating a headway distance control method according to an embodiment of the present disclosure.

First of all, as described above, obtaining the information about the object around the vehicle and detecting whether the driver in the vehicle keeps his or her eyes on the road may be performed in advance.

In S210, a forward gazing detecting device 120 of FIG. 1 may determine whether the driver keeps his or her eyes on the road.

When the driver does not keep his or her eyes on the road, a headway distance controller 130 of FIG. 1 may set a headway level to a predetermined level.

For example, when the driver does not keep his or her eyes on the road as a result of the determination, in S220, the headway distance controller 130 may determine whether the currently set headway level is equal to a maximum headway level. Herein, the maximum headway level may refer to the highest level among levels headway adjustment.

When the currently set headway level is greater than or equal to the maximum headway level as a result of the determination, the headway distance controller 130 may maintain the maximum headway level without additional control.

On the other hands, when the currently set headway level is less than the maximum headway level, in S230, the headway distance controller 130 may set the headway level to the maximum headway level. In other words, the predetermined level may be the maximum headway level.

When the driver keeps his or her eyes on the road, in S240, the headway distance controller 130 may determine whether the headway level is in an auto level-up state.

When the headway level is in the auto level-up state as a result of the determination, in S250, the headway distance controller 130 may return the headway level to an original state to release the auto level-up state.

In other words, a condition for releasing auto settings of the headway level may be when the driver keeps his or her eyes on the road or when the driver changes headway settings in a state where the headway level is automatically set. Of course, when both are met, the auto settings of the headway level may be released.

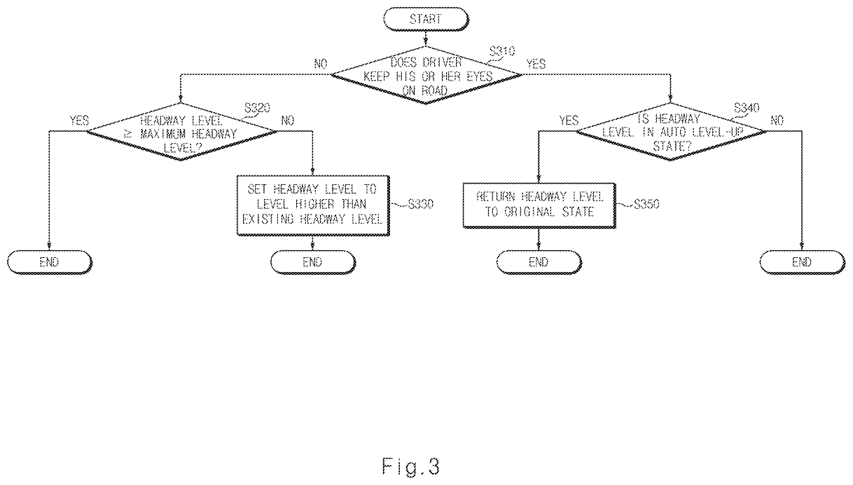

FIG. 3 is a control flowchart illustrating a method for changing a headway level according to an embodiment of the present disclosure.

According to an embodiment, when the driver does not keep his or her eyes on the road, a headway distance controller 130 of FIG. 1 may set a level higher than the headway level set by the driver to a predetermined level.

As shown, in S310, a forward gazing detecting device 120 of FIG. 1 may determine whether the driver keeps his or her eyes on the road.

When the driver does not keep his or her eyes on the road as a result of the determination, in S320, the headway distance controller 130 may determine whether the currently set headway level is greater than or equal to a maximum headway level.

When the currently set headway level is greater than or equal to the maximum headway level as a result of the determination, the headway distance controller 130 may maintain the maximum headway level without additional control.

On the other hands, when the currently set headway level is less than the maximum headway level, in S330, the headway distance controller 130 may set the headway level to a level higher than the existing level set by the driver. In other words, the predetermined level may be the level higher than the existing headway level.

When the driver keeps his or her eyes on the road, in S340, the headway distance controller 130 may determine whether the headway level is in an auto level-up state.

When the headway level is in the auto level-up state as a result of the determination, in S350, the headway distance controller 130 may return the headway level to an original state to release the auto level-up state.

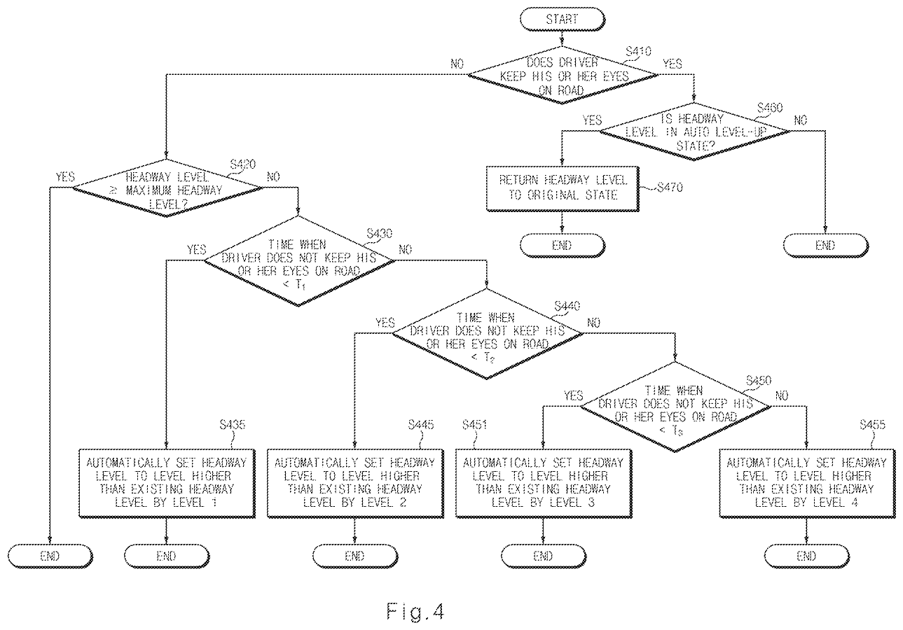

FIG. 4 is a control flowchart illustrating a method for changing a headway level according to another embodiment of the present disclosure.

According to an embodiment, when the driver does not keep his or her eyes on the road, a headway distance controller 130 of FIG. 1 may set a headway level, which becomes gradually higher in response to a time when the driver does not keep his or her eyes on the road, to the predetermined level.

As shown, first of all, when a forward gazing detecting device 120 of FIG. 1 determines that the driver does not keep his or her eyes on the road in S410, in S420, the headway distance controller 130 may determine whether the currently set headway level is greater than or equal to a maximum headway level.

When the currently set headway level is greater than or equal to the maximum headway level as a result of the determination, the headway distance controller 130 may maintain the maximum headway level without additional control.

On the other hands, when the currently set headway level is less than the maximum headway level, in S430, the headway distance controller 130 may determine whether the time when the driver does not keep his or her eyes on the road is less than a first time T₁. When the time when the driver does not keep his or her eyes on the road is less than the first time T₁, in S435, the headway distance controller 130 may automatically set the headway level to a level which is higher than an existing headway level by level 1.

On the other hands, when the time when the driver does not keep his or her eyes on the road is greater than or equal to the first time T₁, in S440, the headway distance controller 130 may determine whether the time when the driver does not keep his or her eyes on the road is less than a second time T₂. When the time when the driver does not keep his or her eyes on the road is less than the second time T₂, in S445, the headway distance controller 130 may automatically set the headway level to a level which is higher than the existing headway level by level 2.

On the other hands, when the time when the driver does not keep his or her eyes on the road is greater than or equal to the second time T₂, in S450, the headway distance controller 130 may determine whether the time when the driver does not keep his or her eyes on the road is less than a third time T₃. When the time when the driver does not keep his or her eyes on the road is less than the third time T₃, in S451, the headway distance controller 130 may automatically set the headway level to a level which is higher than an existing headway level by level 3.

On the other hands, when the time when the driver does not keep his or her eyes on the road is greater than or equal to the third time T₃, in S455, the headway distance controller 130 may automatically set the headway level to a level which is higher than the existing headway level by level 4.

In other words, as there is an increase in the time when the driver does not keep his or her eyes on the road, the headway distance controller 130 may apply a headway level which is gradually higher.

When the driver keeps his or her eyes on the road, in S460, the headway distance controller 130 may determine whether the headway level is in an auto level-up state.

When the headway level is in the auto level-up state as a result of the determination, in S470, the headway distance controller 130 may return the headway level to an original state to release the auto level-up state.

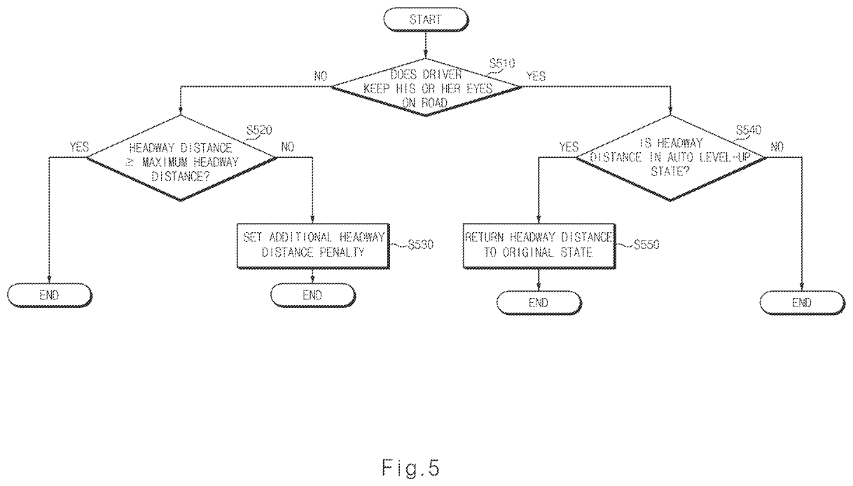

FIG. 5 is a control flowchart illustrating setting an additional headway distance penalty according to an embodiment of the present disclosure.

According to an embodiment, when the driver does not keep his or her eyes on the road, a penalty may be applied to an additional headway distance rather than a predefined headway level.

The additional headway distance according to the penalty may be set to a certain constant, a variable corresponding to a current headway level, a variable corresponding to a current vehicle speed, or the like. Alternatively, the additional headway distance according to the penalty may increase over a time when the driver does not keep his or her eyes on the road, similar to the example described with reference to FIG. 4.

As shown, in S510, a forward gazing detecting device 120 of FIG. 1 may determine whether the driver keeps his or her eyes on the road.

When the driver does not keep his or her eyes on the road as a result of the determination, in 520, a headway distance controller 130 of FIG. 1 may determine whether the currently set headway level is greater than or equal to a maximum headway level.

When the currently set headway level is greater than or equal to the maximum headway level as a result of the determination, the headway distance controller 130 may maintain the maximum headway level without additional control.

On the other hands, when the currently set headway level is less than the maximum headway level, in S530, the headway distance controller 130 may set an additional headway distance penalty.

In this case, the additional headway distance penalty may be set based on one of a current headway level, a current vehicle speed, or a time when the driver does not keep his or her eyes on the road.

When the driver keeps his or her eyes on the road, in S540, the headway distance controller 130 may determine whether the headway distance is in an auto level-up state.

When the headway distance is in the auto level-up state as a result of the determination, in S550, the headway distance controller 130 may return the headway distance to an original state to release the auto level-up state.

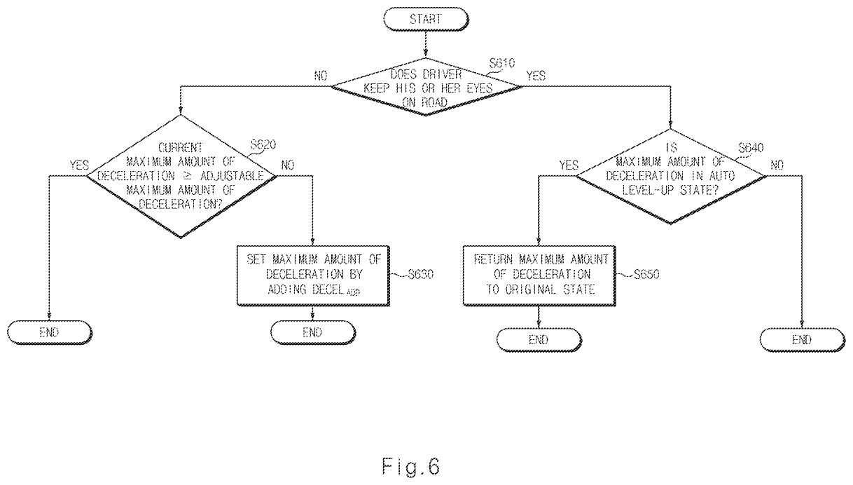

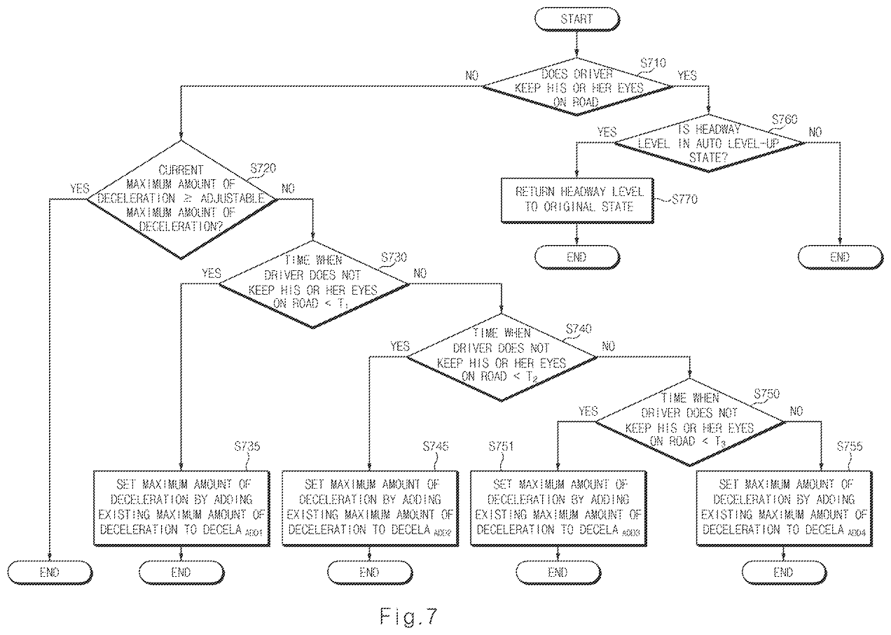

Meanwhile, according to an example, the amount of deceleration may be adjusted by monitoring a driver state. In an existing system, when the headway distance is set to be short, there may be a limit to responding to deceleration using system control limit deceleration, upon emergency braking of a forward vehicle. When the driver keeps his or her eyes on the road, a head-on collision situation may be avoided as the driver manipulates a brake pedal. However, when the driver does not keep his or her eyes on the road, there is a very high probability that a head-on collision will occur. Thus, according to an example, when the driver does not keep his or her eyes on the road, limit deceleration may be adjusted upwardly. FIGS. 6 to 7 are drawings illustrating an example of upwardly adjusting the amount of limit deceleration. As a result, a risk of a head-on collision according to sudden deceleration of a forward vehicle in the situation where the driver does not keep his or her eyes on the road may be reduced.

FIG. 6 is a control flowchart illustrating setting the maximum amount of deceleration according to an embodiment of the present disclosure.

As shown, first of all, when a forward gazing detecting device 120 of FIG. 1 may determine that the driver does not keep his or her eyes on the road in S610, in S620, a headway distance controller 130 of FIG. 1 may determine whether the currently set maximum amount of deceleration is greater than or equal to an adjustable maximum amount of deceleration.

When the currently set maximum amount of deceleration is greater than or equal to the adjustable maximum amount of deceleration as a result of the determination, the headway distance controller 130 may maintain the maximum headway level without additional control.

On the other hands, when the currently set maximum amount of deceleration is less than the adjustable maximum amount of deceleration, in S630, the headway distance controller 130 may set the maximum amount of deceleration by adding an existing maximum amount of deceleration to Decel_{ADD}. Decel_{ADD} may indicate added longitudinal acceleration, that is, the amount of deceleration.

In other words, when the driver does not keep his or her eyes on the road, the headway distance controller 130 may increase the maximum amount of deceleration of a braking system 150 of FIG. 1.

When the driver keeps his or her eyes on the road, in S640, the headway distance controller 130 may determine whether the maximum amount of deceleration is in an auto level-up state.

When the maximum amount of deceleration is in the auto level-up state as a result of the determination, in S650, the headway distance controller 130 may return the maximum amount of deceleration to an original state to release the auto level-up state.

FIG. 7 is a control flowchart illustrating setting the maximum amount of deceleration according to another embodiment of the present disclosure.

According to an example, when the driver does not keep his or her eyes on the road, a headway distance controller 130 of FIG. 1 may add the amount of deceleration, which is gradually increased in response to a time when the driver does not keep his or her eyes on the road.

As shown, first of all, when a forward gazing detecting device 120 of FIG. 1 may determine that the driver does not keep his or her eyes on the road in S710, in S720, the headway distance controller 130 may determine whether the currently set maximum amount of deceleration is greater than or equal to an adjustable maximum amount of deceleration.

When the currently set maximum amount of deceleration is greater than or equal to the adjustable maximum amount of deceleration as a result of the determination, the headway distance controller 130 may maintain the maximum headway level without additional control.

On the other hands, when the currently set maximum amount of deceleration is less than the adjustable maximum amount of deceleration, in S730, the headway distance controller 130 may determine whether a time when the driver does not keep his or her eyes on the road is less than a first time T₁. When the time when the driver does not keep his or her eyes on the road is less than the first time T₁, in S735, the headway distance controller 130 may automatically set the maximum amount of deceleration by adding an existing maximum amount of deceleration to Decel_{ADD1}.

On the other hands, when the time when the driver does not keep his or her eyes on the road is greater than or equal to the first time T₁, in S740, the headway distance controller 130 may determine whether the time when the driver does not keep his or her eyes on the road is less than a second time T₂. When the time when the driver does not keep his or her eyes on the road is less than the second time T₂, in S745, the headway distance controller 130 may automatically set the maximum amount of deceleration by adding the existing maximum amount of deceleration to Decel_{ADD2}.

On the other hands, when the time when the driver does not keep his or her eyes on the road is greater than or equal to the second time T₂, in S750, the headway distance controller 130 may determine whether the time when the driver does not keep his or her eyes on the road is less than a third time T₃. When the time when the driver does not keep his or her eyes on the road is less than the first time T₃, in S751, the headway distance controller 130 may automatically set the maximum amount of deceleration by adding the existing maximum amount of deceleration to Decel_{ADD3}.

On the other hands, when the time when the driver does not keep his or her eyes on the road is greater than or equal to the third time T₃, in S755, the headway distance controller 130 may automatically set the maximum amount of deceleration by adding the existing maximum amount of deceleration to Decel_{ADD4}.

In other words, the headway distance controller 130 may apply the maximum amount of deceleration (Decel_{ADD1}<Decel_{ADD2}<Decel_{ADD3}<Decel_{ADD4}) which increases to a larger width on a stage-by-stage basis as there is an increase in the time when the driver does not keep his or her eyes on the road.

When the driver keeps his or her eyes on the road, in S760, the headway distance controller 130 may determine whether the headway level is in an auto level-up state.

When the headway level is the auto level-up state as a result of the determination, in S770, the headway distance controller 130 may return the headway level to an original state to release the auto level-up state.

According to an example, when the maximum amount of deceleration of the vehicle is adjusted upwardly, the message “The amount of deceleration is raised because the driver does not keep his or her eyes on the road” may be output as a voice or a video by means of a user interface 160 of FIG. 1. Alternatively, a warning or an alarm may be represented as motion such as haptic motion, and a warning message may be delivered in combination of two of an optical signal, an acoustic signal, a haptic signal, or the like.

Furthermore, according to an example, acceleration of the vehicle may be adjusted by monitoring a driver state. In an existing technology, when a forward vehicle accelerates in a situation where a driving speed of the vehicle is slower than a setting speed of the vehicle, a following vehicle behind the vehicle may be configured to also accelerate. At this time, when the vehicle accelerates in the state where the driver does not keep his or her eyes on the road, there may be a more increase in driver injury severity when an accident occurs due to an increase in vehicle speed, and the driver may feel a sense of difference in driving depending on the amount of acceleration. Furthermore, continuing maintaining the headway distance in the state where the driver does not keep his or her eyes on the road may include risk where the risk of a head-on collision is continuously maintained.

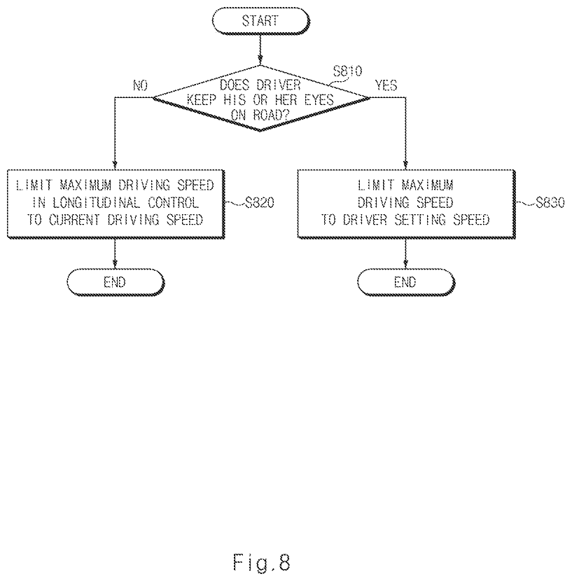

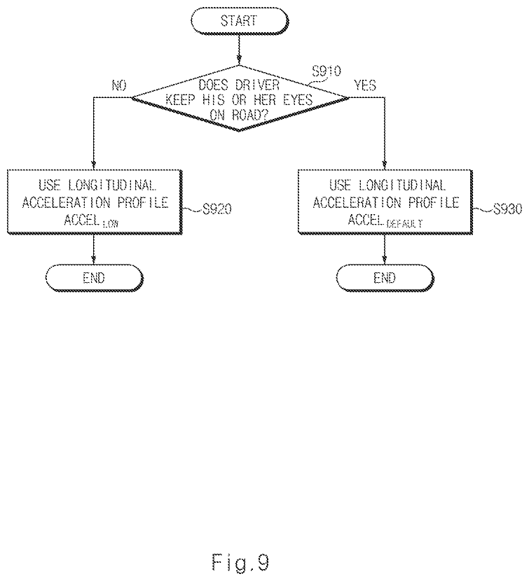

Thus, according to an example, when the driver does not keep his or her eyes on the road, the amount of acceleration for speed control may be adjusted. FIGS. 8 and 9 illustrate an embodiment of adjusting the amount of acceleration. As a result, acceleration of the vehicle by acceleration of a forward vehicle in the situation where the driver does not keep his or her eyes on the road may be limited to prevent a head-on collision with the forward vehicle and reduce driver injury severity when an accident occurs.

FIG. 8 is a control flowchart illustrating a method for limiting a driving speed according to an embodiment of the present disclosure.

As shown, first of all, when a forward gazing detecting device 120 of FIG. 1 may determine that the driver does not keep his or her eyes on the road in S810, in S820, a headway distance controller 130 of FIG. 1 may limit a maximum driving speed in longitudinal control to a current driving speed.

In other words, when the driver does not keep his or her eyes on the road, the headway distance controller 130 may limit a maximum driving speed of the vehicle, and an operation system 140 of FIG. 1 may operate the vehicle depending on the maximum driving speed.

On the other hands, when the driver keeps his or her eyes on the road, in S830, the headway distance controller 130 may limit the maximum driving speed to a driver setting speed.

FIG. 9 is a control flowchart illustrating a method for limiting a driving speed according to another embodiment of the present disclosure.

Meanwhile, according to another example, when a forward gazing detecting device 120 of FIG. 1 may determine that the driver does not keep his or her eyes on the road in S910, in S920, a headway distance controller 130 of FIG. 1 may use a longitudinal acceleration profile Accel_{Low}. Accel_{Low} may be a longitudinal acceleration profile when the driver does not keep his or her eyes on the road.

On the other hands, when the driver keeps his or her eyes on the road, in S930, the headway distance controller 130 may use a longitudinal acceleration profile Accel_{DEFAULT}. Accel_{DEFAULT} may be a longitudinal acceleration profile when the driver keeps his or her eyes on the road.

In other words, the headway distance controller 130 may set the amount of acceleration of the vehicle when the driver does not keep his or her eyes on the road to be lower than the amount of acceleration of the vehicle when the driver keeps his or her eyes on the road, and an operation system 140 may operate the vehicle depending on the set amount of acceleration.

According to an example, when the driving speed of the vehicle is adjusted, the message “The acceleration is limited because the driver does not keep his or her eyes on the road.” may be output as a voice or a video by means of a user interface 160 of FIG. 1. Alternatively, a warning or an alarm may be represented as motion such as haptic motion, and a warning message may be delivered in combination of two of an optical signal, an acoustic signal, a haptic signal, or the like.

According to one aspect, the headway distance controller 130 may send the set values including, but not limited to, the headway level, the maximum amount of deceleration, the maximum driving speed, and the acceleration profile, to the operation system 140 and/or the braking system 150 or may use such values to control the operation system 140 and/or the braking system 150, thereby controlling the vehicle to drive in a corresponding state.

As described above, according to an embodiment of the present disclosure, the system and the method may be provided to suppress the occurrence of the limit situation or enhance a time taken for the driver to response to the limit situation, in the situation where the driver does not keep his or her eyes on the road. Furthermore, the occurrence of the limit situation in longitudinal direction of a conventional driving convenience system may be suppressed, such that an accident may be prevented from occurring due to non-response of the driver or such that a driving safety system such as forward collision-avoidance assist (FCA) may be prevented being enabled.

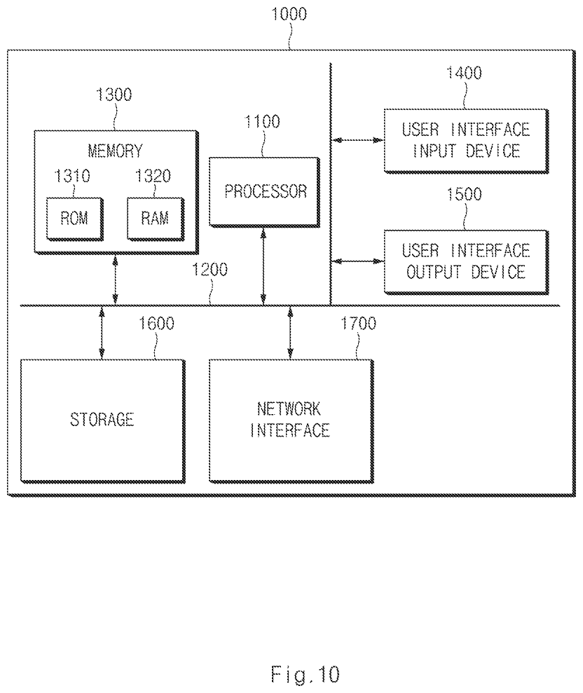

FIG. 10 is a block diagram illustrating a computing system according to an embodiment of the present disclosure.

Referring to FIG. 10, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

An embodiment of the present disclosure may provide the vehicle controller and the headway distance control method using the same to suppress the occurrence of a limit situation or increase a time taken for the driver to respond to the limit situation, when the driver does not keep his or her eyes on the road.

An embodiment of the present disclosure may provide the vehicle controller and the headway distance control method using the same to supplement a limit in longitudinal control of a driving convenience system, such as smart cruise control (SCC) or highway driving assist (HDA), in a situation where the driver does not keep his or her eyes on the road.

An embodiment of the present disclosure may provide the vehicle controller and the headway distance control method using the same to prevent an accident from occurring due to non-response of the driver or prevent a driving safety system, such as forward collision-avoidance assist (FCA), from being enabled.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A vehicle controller, comprising:
an object information obtaining device configured to obtain information about an object around a vehicle;
a forward gazing detecting device configured to detect whether a driver in the vehicle keeps his or her eyes on the road; and
a headway distance controller configured to control a headway distance between the vehicle and a forward vehicle which is traveling in front of the vehicle depending on whether the driver keeps his or her eyes on the road.

2. The vehicle controller of claim 1, wherein the headway distance controller sets a headway level to a predetermined level, when the driver does not keep his or her eyes on the road, and
the vehicle controller further comprises:
an operation system configured to operate the vehicle depending on the set headway level.

3. The vehicle controller of claim 2, wherein the headway distance controller sets the predetermined level to a maximum headway level corresponding to the highest level among levels for headway adjustment.

4. The vehicle controller of claim 2, wherein the headway distance controller sets a level higher than a headway level set by the driver to the predetermined level.

5. The vehicle controller of claim 2, wherein the headway distance controller sets a headway level which becomes higher in response to a time when the driver does not keep his or her eyes on the road to the predetermined level.

6. The vehicle controller of claim 1, wherein the headway distance controller increase a headway distance based on one of a current headway level, a current vehicle speed, or a time when the driver does not keep his or her eyes on the road, when the driver does not keep his or her eyes on the road.

7. The vehicle controller of claim 1, further comprising:
a braking system configured to brake the vehicle,
wherein the headway distance controller increases a maximum amount of deceleration of the braking system, when the driver does not keep his or her eyes on the road.

8. The vehicle controller of claim 7, wherein the maximum amount of deceleration is set based on one of a current vehicle speed, a distance from the forward vehicle, a speed of the forward vehicle, or a time when the driver does not keep his or her eyes on the road.

9. The vehicle controller of claim 1, wherein the headway distance controller limits a maximum driving speed of the vehicle, when the driver does not keep his or her eyes on the road, and
the vehicle controller further comprises:
an operation system configured to operate the vehicle depending on the maximum driving speed.

10. The vehicle controller of claim 1, wherein the headway distance controller sets an amount of acceleration of the vehicle when the driver does not keep his or her eyes on the road to be lower than an amount of acceleration of the vehicle when the driver keeps his or her eyes on the road, and
the vehicle controller further comprises:
an operation system configured to operate the vehicle depending on the set amount of acceleration.

11. The vehicle controller of claim 1, further comprising:
a user interface configured to notify the driver of operation information of the vehicle which is traveling based on a changed headway distance, when the driver does not keep his or her eyes on the road.

12. A headway distance control method, comprising:
obtaining information about an object around a vehicle;
detecting whether a driver in the vehicle keeps his or her eyes on the road; and
controlling a headway distance between the vehicle and a forward vehicle which is traveling in front of the vehicle depending on whether the driver keeps his or her eyes on the road.

13. The headway distance control method of claim 12, wherein the controlling of the headway distance includes setting a headway level to a maximum headway level corresponding to the highest level among levels for headway adjustment, when the driver does not keep his or her eyes on the road.

14. The headway distance control method of claim 12, wherein the controlling of the headway distance includes setting a headway level higher than a headway level set by the driver.

15. The headway distance control method of claim 12, wherein the controlling of the headway distance includes setting a headway level which becomes higher in response to a time when the driver does not keep his or her eyes on the road.

16. The headway distance control method of claim 12, wherein the controlling of the headway distance includes setting an additional headway distance penalty based on one of a current headway level, a current vehicle speed, or a time when the driver does not keep his or her eyes on the road, when the driver does not keep his or her eyes on the road.

17. The headway distance control method of claim 12, wherein the controlling of the headway distance includes increasing a maximum amount of deceleration of the vehicle based on one of a current vehicle speed, a distance from the forward vehicle, a speed of the forward vehicle, or a time when the driver does not keep his or her eyes on the road, when the driver does not keep his or her eyes on the road.

18. The headway distance control method of claim 12, wherein the controlling of the headway distance includes limiting a maximum driving speed of the vehicle, when the driver does not keep his or her eyes on the road.

19. The headway distance control method of claim 12, wherein the controlling of the headway distance includes setting an amount of acceleration of the vehicle when the driver does not keep his or her eyes on the road to be lower than an amount of acceleration of the vehicle when the driver keeps his or her eyes on the road.

20. The headway distance control method of claim 12, further comprising:
notifying the driver of operation information of the vehicle which is traveling based on a changed headway distance, when the driver does not keep his or her eyes on the road.
